(19) United States
(12) Patent Application Publication
(10) Pub. No.: US 2024/0257179 A1
(43) Pub. Date: Aug. 1, 2024

(54) USER INTEREST DETECTION FOR CONTENT GENERATION

(71) Applicant: Salesforce, Inc., San Francisco, CA (US)

(72) Inventors: Jessica Lundin, Bellevue, WA (US); Michael Sollami, Cambridge, MA (US)

(21) Appl. No.: 18/102,591

(22) Filed: Jan. 27, 2023

(51) Int. Cl. G06Q 30/0251; G06Q 30/0241

(52) U.S. Cl. CPC G06Q 30/0254; G06Q 30/0252; G06Q 30/0253; G06Q 30/0277

(57) ABSTRACT

Systems, devices, and techniques are disclosed for user interest detection for content generation. A set of time series data including user interactions with computer accessible resources may be received. A set of expected event data may be received. Irregular event data may be received. A prediction of user interest in an event, including an identification of the event, a time of the event, and levels of user interest before, during and after the time of the event may be generated from the set of time series data, the set of expected event data, and the set of irregular event data. An item of content may be displayed to a user at a time based on the prediction of user interest in the event.

### BACKGROUND

User interests may change with different directions and magnitudes and on different time scales. Changes in user interest may be triggered by expected calendar events, such as holidays, and by irregular events. Without knowing how changes affect user interests, content providers may need to react in an ad-hoc manner to expected events and in a post-hoc manner to irregular events. This may involve either manual modification of content or complex engineering of a generic experimentation set up, such a multi-arm bandit testing, in order to generate content that follows changes in user interest. Content providers may be unable to modify their content in a predictive manner.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for suitable for user interest detection for content generation according to an implementation of the disclosed subject matter.

FIG. 2 shows an example arrangement suitable for user interest detection for content generation according to an implementation of the disclosed subject matter.

FIG. 3A shows an example arrangement suitable for user interest detection for content generation according to an implementation of the disclosed subject matter.

FIG. 3B shows an example arrangement suitable for user interest detection for content generation according to an implementation of the disclosed subject matter.

FIG. 4 shows an example arrangement suitable for user interest detection for content generation according to an implementation of the disclosed subject matter.

FIG. 5 shows an example system suitable for user interest detection for content generation according to an implementation of the disclosed subject matter.

FIG. 6 shows an example arrangement suitable for user interest detection for content generation according to an implementation of the disclosed subject matter.

FIG. 7 shows an example arrangement suitable for user interest detection for content generation according to an implementation of the disclosed subject matter.

FIG. 8 shows an example procedure suitable for user interest detection for content generation according to an implementation of the disclosed subject matter.

FIG. 9 shows a computer according to an implementation of the disclosed subject matter.

FIG. 10 shows a network configuration according to an implementation of the disclosed subject matter.

### DETAILED DESCRIPTION

Techniques disclosed herein enable user interest detection for content generation, which may allow for the generation of predictions of user interest in events and the generation of content based on the predictions. A set of time series data including user interactions with at a computer accessible resource may be received. A set of expected event data may be received. A set of irregular event data may be received. A prediction of user interest in an event including an identification of the event, a time of the event, and levels of user interest before, during and after the time of the event may be generated from the set of time series data and the set of event data. The generated item of content may be displayed to a user at a time based on the prediction of user interest in the event. Topic phrases may be received. The topic phrases may be input to generative systems. A first generative system may generate image content and a second generative system may generate text content. Image content generated by the first generative system may be input to an auto-summarization system to generate additional topic phrases. The additional topic phrases may be input to the at least two generative systems, wherein the first generative system generates additional image content and the second generative system generates additional text content. The image content, additional image content, text content, and additional text content may be input into a third generative system. The third generative system may generate items of candidate content. Each of the items of candidate content may include at least one image from either the image content or the additional image content and text from either the text content or the additional text content.

A set of time series data including user interactions with at a computer accessible resource may be received. The set of time series data may include data for any suitable user interactions with any suitable computer accessible resource. For example, the set of time series data may include telemetry from user interactions with any number of ecommerce webpages. The telemetry may include, for example, user interactions such as webpage impressions, user clicks on webpage hyperlinks, adding of items to a user's cart, and purchasing of items. The computer accessible resource may also be, for example, a communications and messaging platform, a document library or other such file sharing platform, an application run on a computer or smartphone, or a media distribution platform. The user interactions may be events involving the user interacting with the computer accessible resource that may be time stamped. For example, a user accessing a document in a document library may be time stamped and stored in a set of time series data as a user interaction event. Any number of sets of times series data may be received. The received sets of time series data may include user interactions from any number of users with any number of different computer accessible resources which may be of any number of different types. The received sets of time series data may be received on a computing device from any suitable source, including, for example, any suitable databases that may be accessible to the computing device. The received sets of time series data may be updated with new user interactions from any suitable data stream.

A set of expected event data may be received. The set of expected event data may be, for example, a calendar that may include expected events, such as holidays, season changes, sporting events, and other similar events that may expected to occur on dates that can be known in advance either due to being scheduled in advance or to recurring at known intervals, such as annually. The expected event data may include both expected events that have already occurred and expected events that are expected to occur in the future from the time the expected event data is received. This may allow for correlations to be made between the expected event data and the set of time series data, which includes user interactions that have already occurred. Expected event data may be geospatial, as different geographical regions may have different holidays, different season changes, different sporting events, and so on. An appropriate geospatial set of event data may be received depending on the geographical region that the set of event data will be used to generate predictions for. For example, to generate predictions to be used within the United States of America, a set of event data with expected events for the United States of America may be received, and this may different from a set of event data with expected events for use in South America. The expected events in a set of event data may be timestamped based on their expected date of occurrence. Any number of sets of expected event data may be received. The received sets of expected event data may be received on the computing device from any suitable source, including, for example, any suitable databases that may be accessible to the computing device.

A set of irregular event data may be received. The set of irregular event data may be, for example, a time series of irregular events that may have already occurred or may be scheduled to occur in the future but may not have the same regularity as expected events. For example the set of irregular event data may include timestamped events related to the news, including already occurred and ongoing news events, social media, including, for example, social media trends, socio-economic indicators, such as, for example, changes in the levels of stock market indices or employment statistics, announcements from notable persons, such as celebrities and politicians, such as product endorsements, events related to products and/or companies, businesses events such as mass onboarding of new employees, and other irregular events that are not generally scheduled far in-advance and do not recur on regular or predictable basis. Any number of sets of irregular event data may be received. The received sets of irregular event data may be received on the computing device from any suitable source, including, for example, any suitable databases that may be accessible to the computing device.

A prediction of user interest in an event including an identification of the event, a time of the event, and levels of user interest before, during and after the time of the event may be generated from the set of time series data, the set of expected event data, and the set of irregular event data. The event for which the prediction may be generated may be any suitable event from the expected event data or the irregular event data. The prediction may be made at any time relative to the event, including before, during, and after the event. For example, the event may be a holiday included in the set of expected event data, a change of seasons included in the expected event data or may be a celebrity announcement in the set of irregular event data. The prediction of user interest in the event may be generated using any suitable using statistical models or neural network models, which may use the set of time series data, the set of expected event data, and the set of irregular event data. The prediction may include predicted levels of user interest may be in both the event itself and in topics that may be related to the event. The predicated levels of user interest in an event and related topics may cover any suitable period of time both before, during, and after the event occurs, and may be updated at any suitable intervals.

For example, if the event is a change in season from fall to winter, the prediction may include predicted levels of user interest in shopping for winter clothes for a time period before the change in seasons, after the change in seasons, and on the day change in seasons is considered to occur according to the expected event data. This may allow for a determination of when it may be best to display ads to users related to items users might buy for winter. The time periods over which the prediction may include user interest levels may be of any suitable length. For example, the time period before the changes in seasons from fall to winter for which the prediction may include user interest levels may extend back into the prior summer or spring and may extend forward to the end of the new winter. If the event is, for example, a mass onboarding event, the prediction may include user levels of interest in various documents in a document library that may be used by new hires. The predictions may be based on user interactions that are from the geospatial region in which the event for which the prediction is being generated will occur. For example, the prediction for the change of seasons from fall to winter in the North America may be based on user interactions from users located in North America.

The computing device may generate predictions of user interest in any number of events, at any suitable time and intervals. For example, the computing device may generate multiple predictions of user interest in the same expected event and related topics as the scheduled occurrence of the expected event approaches and may continue to generate predictions during and after the occurrence of the event. This may allow predicted user interest levels in an event to be updated both before, during, and after the event based on, for example, new user interactions added to the set of time series data. The predictions may be output by the computing device in any suitable manner and format. For example, the prediction may be output to a content management system which may use the prediction to determine when to display items of content to users

An item of content may be displayed to a user at a time based on the prediction of user interest in the event. The prediction of user interest in the event or related topics may include predicted levels of user interest over time periods from before, during, and after the event. An item of content may be displayed to users based on these predicted levels of user interest, for example, displaying an item of content during periods of rising or peak interest in the event or related topic. For example, an ad for winter clothing may be displayed to a user at a time that the predicted levels of user interest indicate peak interest clothes shopping for the change of seasons from fall to winter. The peak interest in an event or related topic may be located at any point of time relative to the occurrence of the event. The item of content may be any of any suitable content type and may be displayed in any suitable manner. For example, the item of content may be a banner ad that may include pictures and text, and may be displayed to a user who is viewing an ecommerce webpage, or may be sent to the user in an advertising email or other such electronic communication. The item of content may be related to the event or related topic for which the prediction was made in any suitable manner, for example, directly or indirectly referencing the event, or otherwise being relevant to the event. For example, if the event is a change of season from fall to winter, the item of content may be an ad for winter coats that may be displayed to a user who is viewing an ecommerce webpage that sells winter coats at a time when the prediction indicates a peak level of user interest in that event. The item of content may also be a link to, for example, a document from a document library which may be displayed to a user of a communications platform at a predicted time of peak user interest for a mass onboarding event. The item of content displayed to a user may be generated in any suitable manner, including manual and automatic generation. Different items of content may be displayed at various times to various users based on the predicted levels of user interest in the same event. For example, a first item of content may be displayed to users at a predicted peak level of user interest before an event while a second item of content may be displayed to users at a predicted peak level of user interest after the event.

Topic phrases may be received. The topic phrases may be phrases related to any suitable topic, and may, for example, be phrases related to topics that are predicted to have higher level of user interest in the near future. For example, the topic phrases may be related to an event or related topic for which a prediction of user interest was generated. The topic phrases may be received from any suitable source. For example, the topic phrases may be input manually or may be extracted from any suitable source, such as, for example, a computer accessible resource such as a webpage related an event for which a prediction was generated, or received directly from the systems that generate predictions. The topic phrases may be of any suitable length. The topic phrases may be received at, for example, a content management system running on a computing device.

The topic phrases may be input to generative systems. The topic phrases may be input to any number of generative systems which may generate any suitable content. For example, the generative systems may be implemented using generative adversarial networks (GANs). A first generative system of the generative systems may, for example, generate image content based on the input topic phrases. The generated image content may be, for, example, novel images in any suitable format that may appear to be related to the topic phrases. A second generative system may, for example, generate text content based on the input topic phrases. The generated text content may be, for example, text whose content may appear to be related to the topic phrases. The image content and text content generated by the generative systems may be based on the manner in which the generative systems were trained. For example, a generative system may include a GAN that may have been trained to generate image content in the style of advertising banner images for ecommerce webpages, and another generative system may include a GAN that may have been trained to generate text content in the style of copy used in conjunction with banner images on ecommerce webpages. Any number of the generative systems to which the topic phrases are input may generate image content, and any number of the generative systems may generate text content. Any suitable number of items of image content and text content may be generated by the generative system.

Image content generated by the generative systems may be input to an auto-summarization system to generate additional topic phrases. The auto-summarization system may be any suitable system for generating topic phrases by summarizing input image content, such as, for example, a deep neural network. Any number of items of image content may be input to the auto-summarization system, which may generate any number of additional topic phrases. The additional topic phrases may be phrases of any suitable length. The image content input to the auto-summarization system may be image content generated by the generative systems based on input topic phrases that were previously generated by the auto-summarization system. This may allow for the generation of image content and topic phrases with the generative systems to be looped without reusing the topic phrases that were initially input to the generative systems.

The additional topic phrases may be input to the generative systems. The additional topic phrases may be input to any number of the generative systems which may generate any additional image content and additional text content. The first generative system of the generative systems may, for example, generate image content based on the input additional topic phrases. The second generative system may, for example, generate text content based on the input additional topic phrases. Any number of the generative systems to which the additional topic phrases are input may generate additional image content, and any number of the generative systems may generate additional text content. Any suitable number of items of additional image content and additional text content may be generated by the generative system.

The image content, additional image content, text content, and additional text content may be input into an additional generative system. The additional generative system may be a content layout generative system for combining text and images based on generated content layouts. The output of the additional generative system may be content that includes images with text placed within the bounds of the image. The additional generative system may generate candidate content. Each item of candidate content may include images from either the image content or the additional image content and text from the text content or the additional text content. The candidate content may be of any suitable type and in any suitable format. For example, the candidate content may be a banner for a webpage, an ad that may be placed anywhere on webpage, or an entire webpage, and may be an image with text incorporated as part of the image at a position indicated by a content layout as flattened image file, as a layered image file, or a set of a separate image, text, and a content layout that indicates how to position the text on the image.

The topic phrases may also be used to find existing image content. Keywords that are associated with the topic phrases, which may be, for example, related to an event, may be determined in any suitable manner, including through, for example, searching of any suitable databases. The keywords may be used to retrieve already existing image content that may be related to the event, for example, through searching image databases. The existing image content may be input to the auto-summarization system, which may generate further additional topic phrases that may be used as input to the generative systems to generate more image content and text content.

The candidate content may be used in any suitable manner. For example, candidate content generated based on topic phrases for an event for which a prediction of user interest levels was generated may be sent to a content management system which may display items of the candidate content to users based on the predicted levels of user interest. The candidate content may be displayed, for example, as banners or other ads on webpages, as ads within applications, or in emails sent to users.

The generative systems, including the first generative system, the second generative system, and the additional generative system may be hosted on any suitable computing devices, such as, for example, the computing device that runs the content management system.

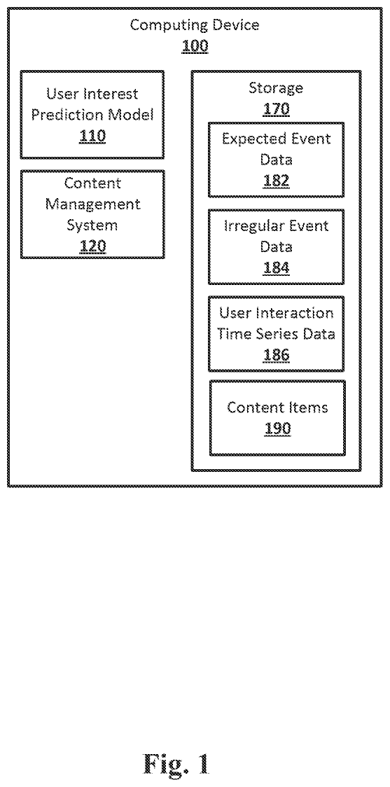

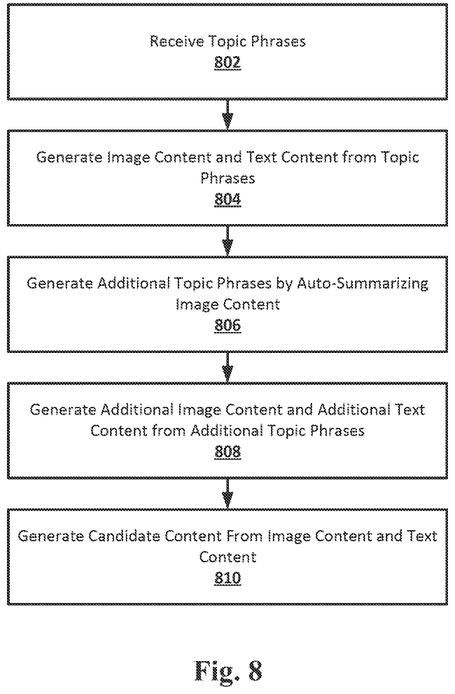

FIG. 1 shows an example system for suitable for user interest detection for content generation according to an implementation of the disclosed subject matter. A computing device 100 may be any suitable computing device, such as, for example, a computer 20 as described in FIG. 9, or component thereof, for implementing user interest detection for content generation.

The computing device 100 may include user interest prediction model 110, a content management system 120, and a storage 170. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs).

The user interest prediction model 110 may be any suitable combination of hardware and software of the computing device 100 for generating predictions of user interest levels in an event or topics related to the event. The user interest prediction model 110 may, for example, be any suitable machine learning model trained to generate predictions of user interest levels in an event, including any suitable neural network, or any suitable statistical model. A prediction of user interest in an event generated by the user prediction model 110 may include an identification of the event, a time of the event, and levels of user interest before, during and after the time of the event. The user interest prediction model 110 may generate predictions of user interest levels in an event or related topics based on, for example, a set of time series data of user interactions, a set of expected event data, and a set of irregular event data. The user interest prediction model 110 may generate predictions for any suitable events or related topics from the expected event data and the irregular event data. For example, the user interest prediction model 110 may generate predictions of user interest levels for a holiday included in the set of expected event data, a change of seasons included in the expected event data, or celebrity announcement, such as an endorsement, in the set of irregular event data. The predicted user interest levels in the event may be generated using any suitable using statistical models or neural network models of the user interest prediction model 110, which may use the set of time series data, the set of expected event data, and the set of irregular event data. The prediction may include predicted levels of user interest in an event or related topics both before, during, and after the event occurs.

The content management system 120 may be any suitable combination of hardware and software of the computing device 100 for managing the distribution and display of content items. The content management system 120 may, for example, be a system for displaying ads on webpages. The content management system 120 may select from among available content items, including, for example, image content, text content, and content layouts for images and text, and determine which content items should be displayed to which users, including the location and timing of the displaying of the content items. The content management system 120 may, for example, determine what ads should be displayed on an ecommerce webpage at a given time. In some implementations, the content management system 120 may mange content in, for example, a content library, such as a document library, and may determine what content items from the content library to display or recommend to users at a given time.

The storage 170 may be any suitable combination of hardware and software for storing data. The storage 170 may include any suitable combination of volatile and non-volatile storage hardware, and may include components of the computing device 100 and hardware accessible to the computing device 100, for example, through wired and wireless direct or network connections. The storage 170 may store, for example, expected event data 182, irregular event data 184, user interaction time series data 186, and the content items 190. The expected event data 182 may be data regard events that are expected to occur, such as scheduled or regularly recurring events. For example, the expected event data 182 may include holiday calendars. The expected event data 182 may include data for both past and future events. Event data in the expected event data 182 may include geospatial data that may indicate the geographical locations at which events occur or are observed. The irregular event data 184 may include data for irregular events, for example, events that are not regularly recurring or generally scheduled, such as produce endorsements or mass onboarding of new hires. Event data in the irregular event data 184 may include times, with any suitable level of precision, and geographic locations for irregular events. The user interaction time series data 186 may include data for any suitable user interactions with any suitable computer accessible resource, such as, for example, telemetry from user interactions with any number of ecommerce webpages. The telemetry may include, for example, user interactions such as webpage impressions, user clicks on webpage hyperlinks, adding of items to a user's cart, and purchasing of items. The user interactions in the user interaction time series data 186 may be events involving the user interacting with the computer accessible resource that may be time stamped.

The expected event data 182, irregular event data 184, and user interaction time series data 186 may be received from any suitable sources and may be updated at any suitable intervals. For example, the user interactions may be continuously streamed into the user interaction time series data 186 as new user interactions occur with computer accessible resources. The expected event data 182, irregular event data 184, and user interaction time series data 186 may be stored in the storage 170, in any other storage device accessible to the computing device 100.

The content items 190 may be items of content such, as for example, image content, text content, and content layouts for images and text. The content items 190 may be stored in the storage 170, in any other storage device accessible to the computing device 100. The content items 190 may include, for example, ads that may be suitable for displaying on ecommerce webpages. In some implementations, the content items 190 may be documents that are part of a document library.

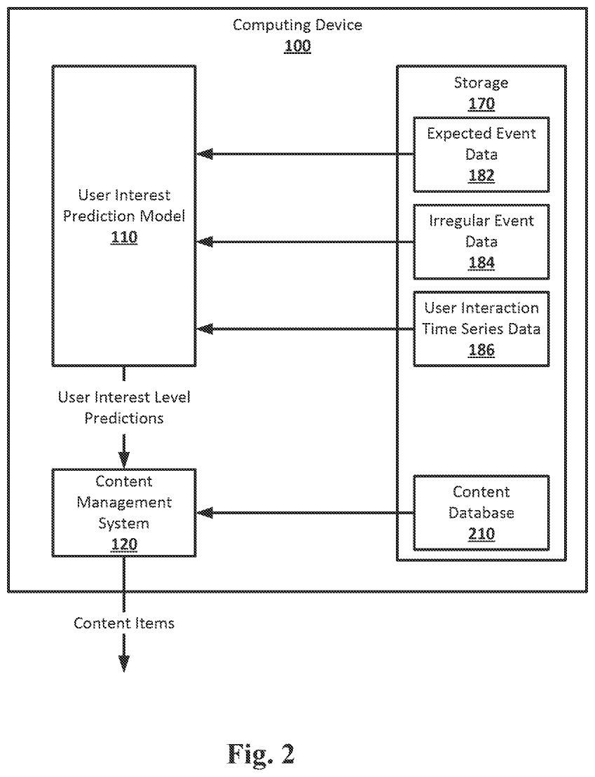

FIG. 2 shows an example arrangement for suitable for user interest detection for content generation according to an implementation of the disclosed subject matter. The user interest prediction model 110 may receive the expected event data 182, irregular event data 184, and user interaction time series data 186 from the storage 170. The user interest prediction model 110 may generate predictions of user interest levels in any events from the expected event data 182 and the irregular event data 184 or in topics related to these events. A user interest level prediction for an event may include an identification of the event, a time of the event, and levels of user interest before, during and after the time of the event. The user level interest predictions may be generated from the expected event data 182, the irregular event data 184, and the user interaction time series data 186. The event for which the prediction may be generated may be any suitable event from the expected event data or the irregular event data. The user interest prediction model 110 may generate user interest level predictions for an event at any time, including before, during, and after the occurrence of the event. For example, the event may be a holiday included in the set of expected event data, a change of seasons included in the expected event data or may be a endorsement annoucement in the set of irregular event data. The user interest prediction model 110 may generate user interest level predictions using any suitable using statistical models or neural network models. The time periods covered by the user interest level prediction generated by the user interest prediction model 110 for an event may be of any suitable length.

The user interest prediction model 110 may generate user interest level predictions for any number of events and related topics, at any suitable time and intervals. For example, the user interest prediction model 110 may generate multiple predictions of user interest in the same expected event and multiple topics related to the expected event as the scheduled occurrence of the expected event approaches and may continue to generate predictions during and after the occurrence of the event. This may allow the user interest level predictions to be updated both before, during, and after the event based on, for example, new user interactions added to the user interaction time series data 186.

The user interest prediction model 110 may output the user interest level predictions to the content management system 120, which may run on the computing device 100, or may run on another computing device that communicates with the computing device 100 through any suitable wired or wireless connection. The content management system 120 may use the user interest level predictions for an event to determine content items from the content database 190 to display to users, including both the time and manner in which the content items are displayed. For example, the content management system 120 may select a content item related to an event to be displayed to users of ecommerce webpages at a time of peak predicted user interest in the event from the user interest level predictions. The content items selected for display by the content management system 120 may be any of any suitable content type and may be displayed in any suitable manner. For example, the content items from the content items 190 may be a banner ad that may include pictures and text, and may be displayed to a user who is viewing an ecommerce webpage, or may be sent to the user in an advertising email or other such electronic communication. The content item selected by the content management system 120 may be related to the event or related topic for which the prediction was made in any suitable manner, for example, directly or indirectly referencing the event, or otherwise being relevant to the event. For example, if the event is a change of season from fall to winter, the item of content may be an ad for winter coats that may be displayed to a user who is viewing an ecommerce webpage that sells winter coats at a time when the prediction indicates a peak level of user interest in that event. The content management system 120 may select content items based on whether the event is approaching and the amount of time until it occurs, is currently occurring, or has already occurred and the amount of time since it has occurred. The content management system 120 may select different content items to be displayed at various times to various users based on the user level interest predictions. The content management system 120 may select content items for any event for which a user interest level prediction was made and may cause the content items to be displayed in any suitable manner by sending the content items to any other suitable systems and computing devices. For example, the content management system 120 may be, or be connected to, a customer relationship management system that may be able to send emails, display ads on webpages, and communicate with users through any other suitable means of electronic communication.

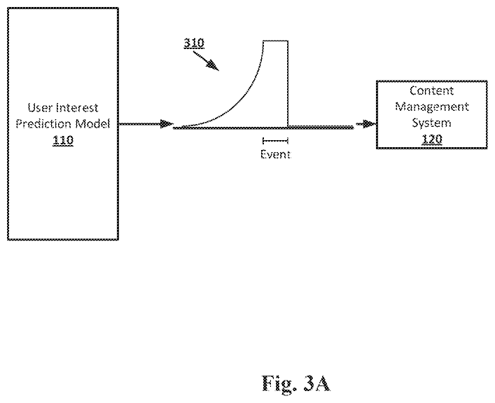

FIG. 3A shows an example arrangement for suitable for user interest detection for content generation according to an implementation of the disclosed subject matter. The user interest prediction model 110 may generate a user interest level prediction 310 for an event from the expected event data 182. The user interest level prediction 310 may show, for example, the user interest rising as the event approaches, peaking for the duration of the event, and then dropping to a negligible level at the end of the event. Based on the user interest level prediction 310, the content management system 120 may determine that content items related to the event should be displayed at various points in time as the event approaches as well as during the event, but not after the event. This determination of the content management system 120 may change as time passes and new user interest level predictions are generated for the event.

FIG. 3B shows an example arrangement for suitable for user interest detection for content generation according to an implementation of the disclosed subject matter. The user interest prediction model 110 may generate a user interest level prediction 320 for an event from the irregular event data 184. The user interest level prediction 320 may show, for example, the user interest rising rapidly as the event approaches, for example, due to the event being irregular and thus being announced as occurring relatively close to the time it actually occurs, peaking during the event, and the dropping for the remainder of the event and after the event. Based on the user interest level prediction 312, the content management system 120 may determine that content items related to the event should be displayed at various points in time as the event approaches as well as during and after the event. This determination of the content management system 120 may change as time passes and new user interest level predictions are generated for the event. The content management system 120 may also manage the display of the content items based on geospatial data for events. For example, if a holiday is only observed in a particular country, the content management system 120 may cause items displayed based a user interest level prediction for that holiday to only be displayed to users who appear to be geolocated in or near the country that observes the holiday.

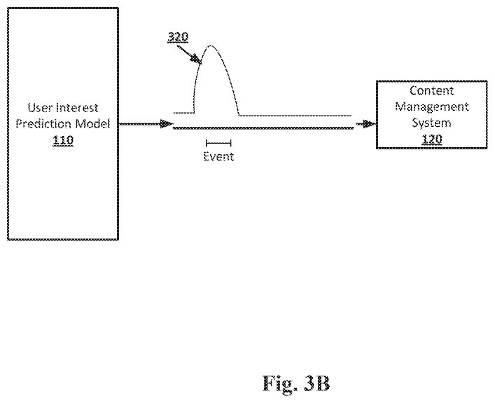

FIG. 4 shows an example system for suitable for user interest detection for content generation according to an implementation of the disclosed subject matter. The computing device 100 may include a content generation system 410. The content generation system 410 may any suitable combination of hardware and software for generating content times that may be stored with the content items 190, including content items that combine text and images. The content generation system 410 may use any number of generative systems, including, for example, generative systems that generate text content, generative systems that generate image content, and a generative system for content layout. The content generation system 410 may take topic phrases as input, and the content items output by the content generation system 410 may be related to the input topic phrases.

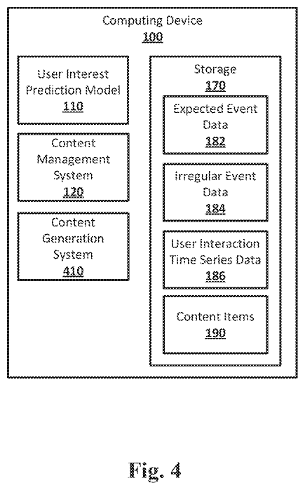

FIG. 5 shows an example arrangement for suitable for user interest detection for content generation according to an implementation of the disclosed subject matter. Topic phrases may be input to the content generation system 410. The topic phrases may be received from any suitable source, such as, for example, the user prediction model 110, which may output topic phrases for events and related topics that the user interest prediction model 110 predicts a high level of user interest in.

The topic phrases received at the content generation system 410 may be input to any number of generative systems. For example, the topic phrases may be input to an image generator 520 and a text generator 530. The image generator 520 may include any suitable generative system, or multiple generative systems, for generating items of image content based on the input topic phrases, for example, images that may be related to the topic phrases by depicting the topic phrases or concepts related to the topic phrases. Generative systems included in the image generator 520 may be, for example, implemented using GANs. The text generator 530 may include any suitable system, or multiple generative systems, for generating items of text based on input topic phrases, for example, words and phrases that may be related to the topic phrases. Generative systems included in the text generator 530 may be, for example, implemented using GANs.

The image generator 520 may generate and output image content based on the input topic phrases. The image generator 520 may generate and output any suitable number of items of image content for any input topic phrase. The text generator 530 may generate and output text content based on the input topic phrases. The text generator 530 may generate and output any suitable number of items of text content for any input topic phrase.

The image content generated and output by the image generator 520 and the text content generated by the text generator 530 may be input to the layout generator 540. The layout generator 540 may include any suitable generative system, or multiple generative systems, for generating items candidate content items from image content and text content. The candidate content items output by the layout generator 540 may include images from the image content overlaid with text from the text content. The image content and text content used by the layout generator 540 to generate a candidate content item may have been generated based on the same input topic phrase, or topic phrases that are related. For example, multiple topic phrases related to the same event for which a user interest level prediction was generated may be used as input to the content generation system 410, and the layout generator 540 may generate candidate content items that may be displayed users in conjunction with that event using the image content and text content generated from those multiple topic phrases. The candidate content items may be of any suitable type and in any suitable format. For example, a candidate content item may be a banner for a webpage, an ad that may be placed anywhere on webpage, or an entire webpage, and may be an image with text incorporated as part of the image at a position indicated by a content layout, or separate image, text, and a content layout that indicates how to position the text on the image. The candidate content items may be output to the content items 190, where they may be stored and made available for use by, for example, the content management system 120. The content management system 120 may select candidate content items from the content items 190 that were generated based on an input topic phrase for display to users based on user interest level predictions for the event to which the input topic phrase is related.

The image content generated by the image generator 520 may also be input to an auto-summarizer 550. The auto-summarizer 550 may be any suitable system for generating topic phrases by summarizing input image content, such as, for example, a deep neural network. Any number of items of image content from the image generator 520 may be input to the auto-summarization system, which may generate any number of additional topic phrases. The additional topic phrases may be phrases of any suitable length. The topic phrases generated by the auto-summarizer 550 may be input to the image generator 520 and the text generator 530 in the same manner that the topic phrases are originally input to the image generator 520 and the text generator 520 from a source such as the user interest prediction model 110. The image generator 520 and text generator 530 may generate additional image content and text content based on the topic phrases generated by the auto-summarizer 550, which may be used along with any previously generated image content and text content by the layout generator 540. The additional image content may also be input to the auto-summarizer 550, creating a loop that may allow for the continuous generation of content based on the topic phrases originally input to the content generation system 410.

The content generation system 410 may also find existing image content based on the topic phrases. The content generation system 410 may determine keywords that are associated with the topic phrases, for example, by searching suitable databases that may be external to the computing device 100. The content generation system 410 may use these keywords to retrieve already existing image content by, for example, searching image databases that may be external to the computing device 100. The existing image content retrieved by the content generation system 410 may be used as input to the auto-summarizer 550. The auto-summarizer 550 may summarize the existing image content to generate further additional topic phrases that may be used as input to the image generator 520 and the text generator 530.

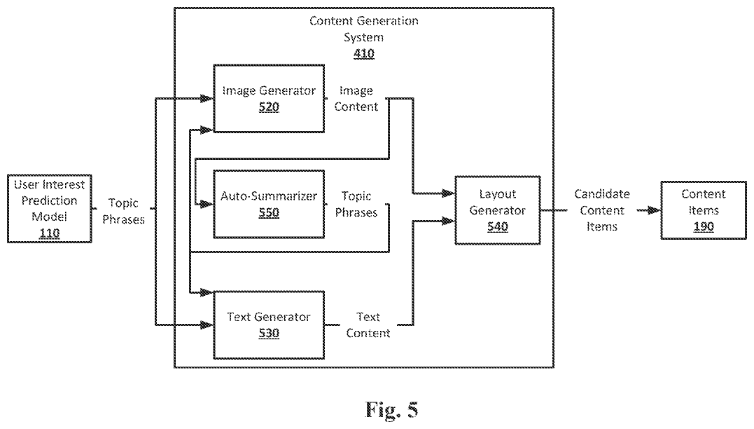

FIG. 6 shows an example arrangement for suitable for user interest detection for content generation according to an implementation of the disclosed subject matter. Topic phrases input to the content generator system 410 may be, for example, the topic phrases 600, “Winter Season, Styles.” The topic phrases may be received from, for example, the user interest prediction model 110 which may have generated a user interest level prediction for the change of seasons from fall to winter with regards to clothing. The topic phrases 600 may be input to the image generator 420 and the text generator 430. The image generator 420 may generate image content related to the input topic phrases, such as, for example, image content item 610, which may be an image depicting objects related to both winter and clothing. The text generator 430 may generate text content related to the input topic phrases, such as, for example, text content item 620, which may be a phrase related to winter and clothing. The layout generator 440 may overlay the text content item 620 on the image content item 610, generating the candidate content item 630. The candidate content item 630 may be a content item that includes both images and text related to the input topic phrases. The content management system 120 may select the candidate content item 630 to be displayed to users, for example, as an ad on a webpage or in an advertising email sent to the users, at a time of peak user interest in the change of seasons from fall to winter and related clothing as indicated by user interest level predictions generated by the user interest prediction model 110.

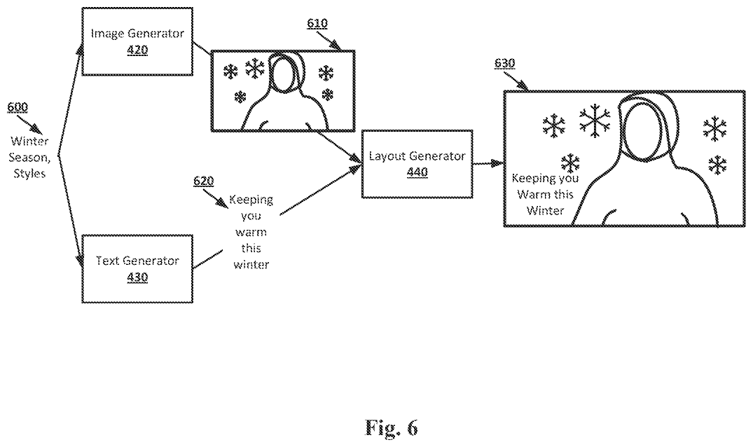

FIG. 7 shows an example procedure suitable for user interest detection for content generation according to an implementation of the disclosed subject matter. At 702, user interaction time series data may be received. For example, the user interest prediction model 110 may receive the user interaction time series data 186 from the storage 170. The user interaction time series data 186 may have been received at the computing device 100 from any suitable sources, and may be continually updated as additional user interactions are collected.

At 704, expected event data may be received. For example, the user interest prediction model 110 may receive the expected event data 182 from the storage 170. The expected event data 182 may include any suitable number of expected events over any suitable period of time and may be updated at any suitable intervals from any suitable sources. The expected event data 182 may, for example, include data from calendars and event schedules. The expected event data 182 may include geospatial data for events indicating regions where events take place or are observed.

At 706, irregular event data may be received. For example, the user interest prediction model 110 may receive the irregular event data 184 from the storage 170. The irregular event data 184 may include any suitable number of irregular events over any suitable period of time and may be updated at any suitable intervals from any suitable sources. The irregular event data 184 may, for example, include data from news feed and social media monitoring. The irregular event data 184 may include geospatial data for events indicating regions where irregular events are taking, or are expected to take, place.

At 708, user interest level predictions may be generated. For example, the user interest prediction model 110 may use the user interaction time series data 186 to generate predictions of user interest levels in events from both the expected event data 182 and the irregular event data 184. The user interest prediction model 110 may generate user interest level predictions for any number of different events, and the predictions for an event may cover any period of time from before, during, and after the event. The user interest level predictions for an event may be based on, for example, the type and quantity of user interactions present in the user interaction time series data 182 for previous occurrences of the event, previous occurrences of events similar to the event, and for the event itself as the event approaches, occurs, and ends. The user interest prediction model 110 may generate user interest level predictions on a continuous basis as, for example, events approach, occur, and end, and the user interaction time series data 702 is updated with additional user interactions both related and not related to the events for which predictions are generated.

At 710, content items that are related to the events may be determined. For example, the user interest prediction model 110 may output the generated user interest level predictions for events to the content management system 120. The content management system 120 may determine content items related to the events from among the content items 190. Content items related to an event may be, for example, candidate content items generated by the content generation system 410 based on topic phrases that are related to the event. The content generation system 410 may have received these topic phrases from, for example, the user interest prediction model 110.

At 712 content items may be displayed to users at times selected based on the user interest level predictions. For example, the content management system 120 may send the content items selected for an event to be displayed to users at times of high predicted levels of user interest in the event. The content items may be displayed in any suitable manner, including, for example, as regular ads or banners on webpages, in emails sent to users, or as in-application ads. The content management system 120 may determine where the content items related to an event are displayed, or which users the content items are sent to or displayed to, based on geospatial data for the event. This may ensure that content items related to events that occur, are observed, or are relevant in specific geographic regions are displayed to users in those geographic regions, as those may be the regions responsible for higher levels of user interest in those events.

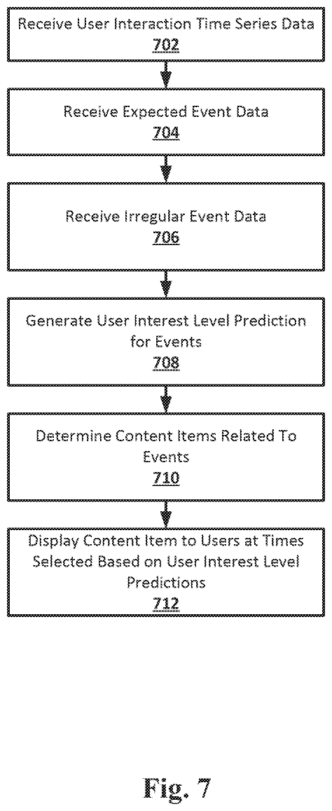

FIG. 8 shows an example procedure suitable for user interest detection for content generation according to an implementation of the disclosed subject matter. At 802, topic phrases may be received. For example, the content generation system 410 may receive topic phrases from any suitable source such as the user interest prediction model 110. The topic phrases may be text phrases of any suitable length that may be related to a specific topic, such as, for example, an event for which a user interest level prediction as generated by the user interest prediction model 110. The topic phrases, received from sources external to the content generation system 410, may be the initial topic phrases that may start the generation of content items related to the topic phrases.

At 804, image content and text content may be generated from the topic phrases. For example, the topic phrases may be input to the image generator 520 and the text generator 530. The generative systems of the image generator 520 may generate images that may be related to the topic phrases, for example depicting objects that are or are related to the topic phrases. Generative systems of the image generator 520 may have been trained to generate specific types of images based on input topic phrases, such as, for example, images suitable for use in various types of advertisements including regular and banner ads for webpages and marking emails. The generative systems of the text generator 530 may generate text content that may be related to the topic phrases, for example, describing concepts related to the topic phrases. Generative systems of the text generator 520 may have been trained to generate specific styles of text content based on input topic phrases, such as, for example, text content suitable for use as ad copy.

At 806, additional topic phrases may be generated by auto-summarizing the image content. For example, the image content generated by the image generator 520 may be input to the auto-summarizer 550. The auto-summarizer 550 may generate text summaries of the images in the image content. The text summaries may be used as topic phrases in addition to the topic phrases that were input to the image generator 520 to generate the image content.

At 808, additional image content and additional text may be generated from the additional topic phrases. For example, the additional topic phrase generated by the auto-summarizer 550 may be used as input to the image generator 520 and the text generator 530, which may generate, respectively, additional image content and additional text content. Because the additional topic phrases may be text summaries of images generated by image generator 520 based on the initial topic phrases, the additional image content and additional text content may be related to the initial topic phrases. The additional image content may also be input to the auto-summarizer 550 to generate further additional topic phrases which may in turn be used to generate further additional image content and text content, and this may be repeated any suitable number of times, resulting in the generation of any suitable amount of image content and text content.

At 810, candidate content may be generated from the image content and the text content. For example, all of the image content and text content generated by the image generator 520 and the text generator 530, including image content and text content generated based on the initial topic phrases and any additional image content and text content generated based on topic phrases generated by the auto-summarizer 550, may be input to the layout generator 540. The layout generator 540 may combine the image content and text content in any suitable manner to generate candidate content items. The candidate content items may, for example, include images from the image content overlaid with text from the text content. The text content may be overlaid on the image content in any suitable manner, using any suitable placement and style. The generative systems of the layout generator 540 may have been trained to generate specific types of candidate content items, such as, for example, image and text combinations that may be suitable for use in various types of advertisements including regular and banner ads for webpages and marking emails. The layout generator 540 may generate any suitable number of candidate content items in any suitable format using the image content and the text content. Candidate content items may be, for example, flattened or layered image files, The candidate content items may be stored, for example, in the content items 190, where they may be accessible to the content management system 120.

Implementations of the presently disclosed subject matter may be implemented in and used with a variety of component and network architectures. FIG. 9 is an example computer 20 suitable for implementing implementations of the presently disclosed subject matter. As discussed in further detail herein, the computer 20 may be a single computer in a network of multiple computers. As shown in FIG. 9, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

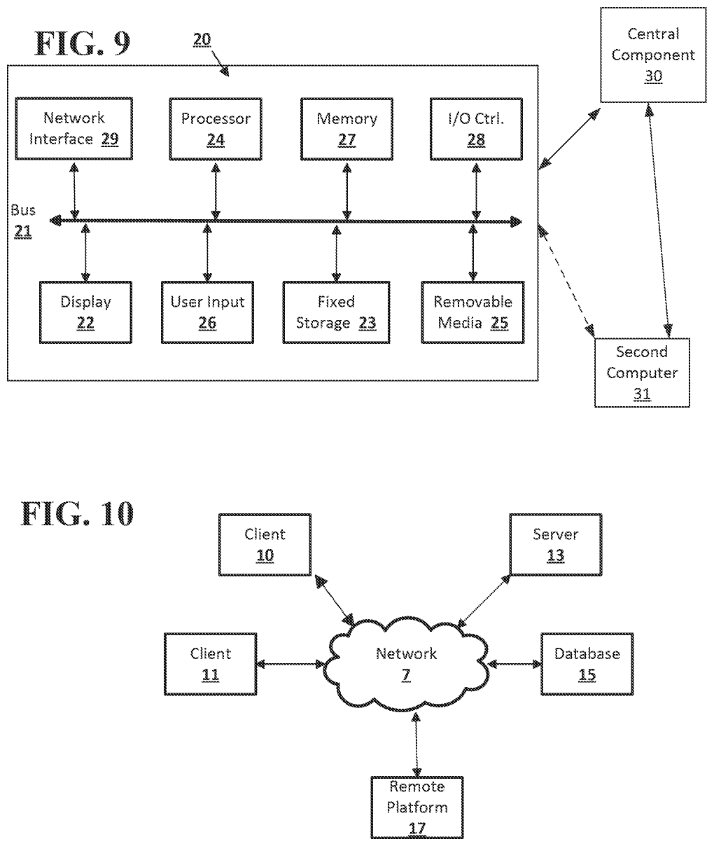

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 10.

Many other devices or components (not shown) may be connected in a similar manner (e.g., document scanners, digital cameras and so on). Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, removable media 25, or on a remote storage location.

FIG. 10 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, at a computing device, at least one set of time series data comprising user interactions with at least one computer accessible resource;
receiving, at the computing device, at least one set of expected event data;
receiving, at the computing device, at least one set of irregular event data;
generating, by the computing device, from the at least one set of time series data, the at least one set of expected event data and the at least one set of irregular event data, a prediction of user interest in an event, the prediction of user interest in the event comprising an identification of the event, a time of the event, and one or more levels of user interest before, during and after the time of the event;
generating, by the computing device, at least one item of content based on at least one topic phrase associated with the event by generating at least one item of image content using a first generative adversarial network (GAN) and the at least one topic phrase, at least one item of text content using a second GAN and the at least one topic phrase, and combining the at least one item of image content and the at least one item of text content into the at least one item of content using a third GAN; and
displaying, to at least one user, the at least one item of content at a time based on a level of peak user interest from the prediction of user interest in the event.

2. The computer-implemented method of claim 1, wherein generating, by the computing device, from the at least one set of time series data, the at least one set of expected event data, and the at least one set of irregular event data, a prediction of user interest in an event further comprises using one or more of a statistical model and a neural network model.

3. The computer-implemented method of claim 1, wherein the at least one set of time series data comprises user interactions with one or more ecommerce webpages.

4. The computer-implemented method of claim 1, wherein the at least one set of expected event data comprises a holiday calendar.

5. The computer-implemented method of claim 1, wherein the at least one item of content comprises a banner ad, and wherein displaying the at least one item of content comprises the displaying the at least one item of content on at least one ecommerce webpage.

6. The computer-implemented method of claim 1, wherein the at least one set of expected event data comprises geospatial data.

7. The computer-implemented method of claim 1, wherein the at least one item of content is related to the event.

8. A computer-implemented system comprising:
one or more storage devices; and
a processor that receives at least one set of time series data comprising user interactions with at least one computer accessible resource,
receives at least one set of expected event data,
receives at least one set of irregular event data,
generates from the at least one set of time series data, the at least one set of expected event data and the at least one set of irregular event data, a prediction of user interest in an event, the prediction of user interest in the event comprising an identification of the event, a time of the event, and one or more levels of user interest before, during and after the time of the event,
generates at least one item of content based on at least one topic phrase associated with the event by generating at least one item of image content using a first generative adversarial network (GAN) and the at least one topic phrase, at least one item of text content using a second GAN and the at least one topic phrase, and combining the at least one item of image content and the at least one item of text content into the at least one item of content using a third GAN; and
displays the at least one item of content at a time based on a level of peak user interest from the prediction of user interest in the event.

9. The computer-implemented system of claim 8, wherein the processor generates from the at least one set of time series data, the at least one set of expected event data, and the at least one set of irregular event data, a prediction of user interest in an event by using one or more of a statistical model and a neural network model.

10. The computer-implemented system of claim 8, wherein the at least one set of time series data comprises user interactions with one or more ecommerce webpages.

11. The computer-implemented system of claim 8, wherein the at least one set of expected event data comprises a holiday calendar.

12. The computer-implemented system of claim 8, wherein the at least one item of content comprises a banner ad, and wherein the processor displays the at least one item of content by displaying the at least one item of content on at least one ecommerce webpage.

13. The computer-implemented system of claim 8, wherein the at least one set of expected event data comprises geospatial data.

14. The computer-implemented system of claim 8, wherein the at least one item of content is related to the event.

15. A system comprising: one or more computers and one or more non-transitory storage devices storing instructions which are operable, when executed by the one or more computers, to cause the one or more computers to perform operations comprising:
receiving, at a computing device, at least one set of time series data comprising user interactions with at least one computer accessible resource;
receiving, at the computing device, at least one set of expected event data;
receiving, at the computing device, at least one set of irregular event data;
generating, by the computing device, from the at least one set of time series data, the at least one set of expected event data and the at least one set of irregular event data, a prediction of user interest in an event, the prediction of user interest in the event comprising an identification of the event, a time of the event, and one or more levels of user interest before, during and after the time of the event;
generating, by the computing device, at least one item of content based on at least one topic phrase associated with the event by generating at least one item of image content using a first generative adversarial network (GAN) and the at least one topic phrase, at least one item of text content using a second GAN and the at least one topic phrase, and combining the at least one item of image content and the at least one item of text content into the at least one item of content using a third GAN; and
displaying, to at least one user, the at least one item of content at a time based on a level of peak user interest from the prediction of user interest in the event.

16. The system of claim 15, wherein the instructions which are operable, when executed by the one or more computers, to cause the one or more computers to further perform operations comprising generating, by the computing device, from the at least one set of time series data, the at least one set of expected event data, and the at least one set of irregular event data, a prediction of user interest in an event further comprise instructions which are operable, when executed by the one or more computers, to cause the one or more computers to perform operations comprising:
using one or more of a statistical model and a neural network model

17. The system of claim 15, wherein the at least one set of time series data comprises user interactions with one or more ecommerce webpages.

18. The system of claim 15, wherein the at least one set of expected event data comprises a holiday calendar.

19. The system of claim 15, wherein the at least one item of content comprises a banner ad, and wherein the one or more computers and one or more non-transitory storage devices further store instructions which are operable, when executed by the one or more computers, to cause the one or more computers to further perform operations comprising:
displaying the at least one item of content comprises the displaying the at least one item of content on at least one ecommerce webpage.

20. The system of claim 15, wherein the at least one set of expected event data comprises geospatial data.
